(19) United States
(12) Patent Application Publication
(10) Pub. No.: US 2010/0158131 A1
(43) Pub. Date: Jun. 24, 2010

(54) ITERATIVE DVC DECODER BASED ON ADAPTIVELY WEIGHTING OF MOTION SIDE INFORMATION

(75) Inventors: Axel Lakus-Becker, Artarmon (AU); Zhonghua Ma, North Epping (AU)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/635,152

(22) Filed: Dec. 10, 2009

(30) Foreign Application Priority Data
Dec. 18, 2008 (AU) 2008259744

(51) Int. Cl. H04N 7/26

(52) U.S. Cl. 375/240.25; 375/E07.027

(57) ABSTRACT

A method of decoding a frame (1110) of video data is disclosed. The data is encoded in a format having a first field (1031) comprising a plurality of encoded key frames and a second field (1032A; 1032B) comprising data facilitating error correction of an approximation of the frame to be decoded using the first field. The method decodes (1140; 1240) at least two key frames from the first field and then determines the approximation (1157; 1257) of the frame from the decoded key frames. The method then determines (1125; 1225) a reliability (1165; 1265) for each of at least parts of the approximation, and applies (1080; 1280) the data (1032A; 1032B) facilitating error correction to the approximation (1157; 1257) of the frame, based on the determined reliabilities for the parts to thereby form the decoded frame (1135; 1235=1110).

### CROSS-REFERENCE TO RELATED PATENT APPLICATIONS

This application claims the right of priority under 35 U.S.C. §119 based on Australian Patent Application No. 2008259744, filed Dec. 18, 2008, which is incorporated by reference herein in its entirety as if fully set forth herein.

### TECHNICAL FIELD

The present invention relates generally to video encoding and decoding and, in particular, to an iterative DVC decoder based on motion side information.

### BACKGROUND

Various products, such as digital (still) cameras and digital video cameras, are used to capture images and videos. These products contain an image sensing device, such as a charge coupled device (CCD), which is used to capture light energy focussed on the image sensing device that is indicative of a scene. The captured light energy is then processed to form a digital image. Various formats are used to represent such digital images, or videos. Formats used to represent video include JPEG, JPEG2000, Motion JPEG, Motion JPEG2000, MPEG1, MPEG2, MPEG4 and H.264.

All the formats listed above have in common that they are compression formats. While these formats offer high quality and improve the number of images that can be stored on a given media, they typically suffer from long encoding runtime. For a conventional format, such as JPEG, JPEG2000, Motion JPEG, Motion JPEG2000, MPEG1, MPEG2, MPEG4 and H.264, the encoding process is typically five to ten times more complex than the decoding process.

A complex encoder requires complex hardware. Complex encoding hardware in turn is disadvantageous in terms of design cost, manufacturing cost and physical size of the encoding hardware. Furthermore, a long encoding runtime can result in delays in the operation of the camera shutter, thus reducing the capture rate. Additionally, more complex encoding hardware has higher battery consumption. An extended battery life is desirable for a mobile device, then it is desirable that battery consumption is minimized in mobile devices.

To minimize the complexity of an encoder, Wyner Ziv coding, or “distributed video coding”, may be used. In a distributed video coding (DVC) scheme, some of the to complexity is shifted from the encoder to the decoder. The input video stream is usually split into two parts, namely key frames and non-key frames. The key frames are compressed using a conventional coding scheme, such as JPEG, JPEG2000, Motion JPEG, Motion JPEG2000, MPEG1, MPEG2, MPEG4 and H.264, and the decoder conventionally decodes the key frames. On the other hand, the non-key frames are firstly predicted at the decoder with the help of the key frames. Such a prediction processing is equivalent to carrying out motion estimation which is usually performed at a conventional encoder. Then, the video quality of the predicted non-key frames is further improved using parity information provided by the encoder for the non-key frames.

For a DVC scheme, the visual quality of the decoded video stream depends heavily on the quality of the prediction of non-key frames. Such a prediction is usually generated from adjacent key frames through motion estimation and temporal interpolation, thus producing a rough estimate of the encoded non-key frames. Any mismatch between the predicted non-key frame and the encoded non-key frame is corrected by channel coding techniques through the usage of parity bits. Specifically, each parity bit carries some information about one or more information bits in the encoded non-key frames. These parity bits are decoded in a DVC decoder to correct prediction errors, with the help of the information bits extracted from the predicted non-key frame. The bit rate of the parity bit stream can vary to achieve a rate-distortion performance desirable for a particular application.

Most of the DVC decoders developed so far comprise a turbo decoder as a core module. The parity bits from the encoder and the information bits generated from the predicted non-key frame are joint-decoded in the turbo decoder in an iterative manner. In a baseline DVC decoding scenario, the information bits (or systematic bits) and the parity bits are assumed to have similar noise distribution. Thus, the same reliability weight is assigned to the systematic bits and the parity bits during the iterative decoding process. Such an iteration decoding process stops when a preset termination criterion has been met. The output of the turbo decoder is used to form pixels of the reconstructed non-key frames.

Several approaches have been proposed in literature to further improve the DVC decoder performance for a given parity bit rate.

One approach realizes the fact that the systematic bits input to a turbo decoder usually suffer much higher distortion than the parity bits (due to motion prediction in the DVC decoder). Hence the error correction capability of the turbo decoder can be boosted by assigning a much higher reliability weight to the parity bits than that of the systematic bits during the iterative decoding process.

Another approach tries to generate much more reliable systematic bits through an iterative decoding and iterative motion prediction process. i.e., the non-key frame produced by the previous DVC decoding iteration is fed back to the motion prediction to enable a better approximation of the non-key frames (from which the systematic bits are generated) in the current decoding iteration.

### SUMMARY

It is an object of the present invention to substantially overcome, or at least ameliorate, one or more disadvantages of existing arrangements.

Described herein is a new method of iterative DVC decoding and motion prediction which can further improve the iterative DVC decoder performance without requiring additional parity bits from the DVC encoder.

According to an aspect of the present invention, there is provided a method of decoding a frame of video data encoded in a format having a first field comprising a plurality of encoded key frames and a second field comprising data facilitating error correction of an approximation of the frame to be decoded using the first field, said method comprising the steps of:

(i) decoding at least two key frames from the first field;

(ii) determining the approximation of the frame from the decoded key frames;

(iii) determining a reliability (1165; 1265) for each of at least parts of the approximation; and

(iv) applying said data facilitating error correction to the approximation of the frame, based on the determined reliabilities for said parts to thereby form the decoded frame.

According to another aspect of the present invention, there is provided a method of decoding a non-key frame of a stream of frames of video data encoded in a format having a first field comprising a plurality of encoded key frames and a second field comprising parity data facilitating reconstruction of the non-key frame to be decoded, said method comprising the steps of:

(i) decoding at least two key frames from the first field;

(ii) determining an approximation frame from the decoded key frames;

(iii) determining a reliability for of the approximation frame; and

(iv) applying said parity data to the approximation frame, based on the determined reliability to thereby form the decoded non-key frame.

Other aspects are also disclosed.

### BRIEF DESCRIPTION OF THE DRAWINGS

At least one embodiment of the present invention will now be described with reference to the drawings, in which:

FIG. 1A shows a schematic block diagram of a system for encoding an input video, for storing or transmitting the encoded video, and for decoding the encoded video;

FIG. 1B shows a schematic flow diagram for the encoder module 1022 to encoding non-key frames in the pixel domain.

FIG. 1C shows a schematic flow diagram for the encoder module 1022 to encoding non-key frames in the transform domain.

FIG. 1D shows a schematic block diagram of a joint decoder for decoding the bit stream produced by the encoder of FIG. 1B;

FIG. 1E shows a schematic block diagram of a joint decoder for decoding the bit stream produced by the encoder of FIG. 1C;

FIG. 2 shows a schematic block diagram of a turbo encoder;

FIG. 3 shows a schematic block diagram of a turbo decoder in which similarity information is used;

FIG. 4 shows a schematic flow diagram of measure the structural similarity for a predicted non-key frame;

FIG. 5 shows a schematic flow diagram of the process performed in a component decoder of the turbo decoder of FIG. 3;

FIG. 6 shows a schematic block diagram of a computer system in which the system shown in FIG. 1A may be implemented; and

FIG. 7 is an illustration of the spatial and temporal neighbour blocks used by the structural similarity measure of FIG. 4.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

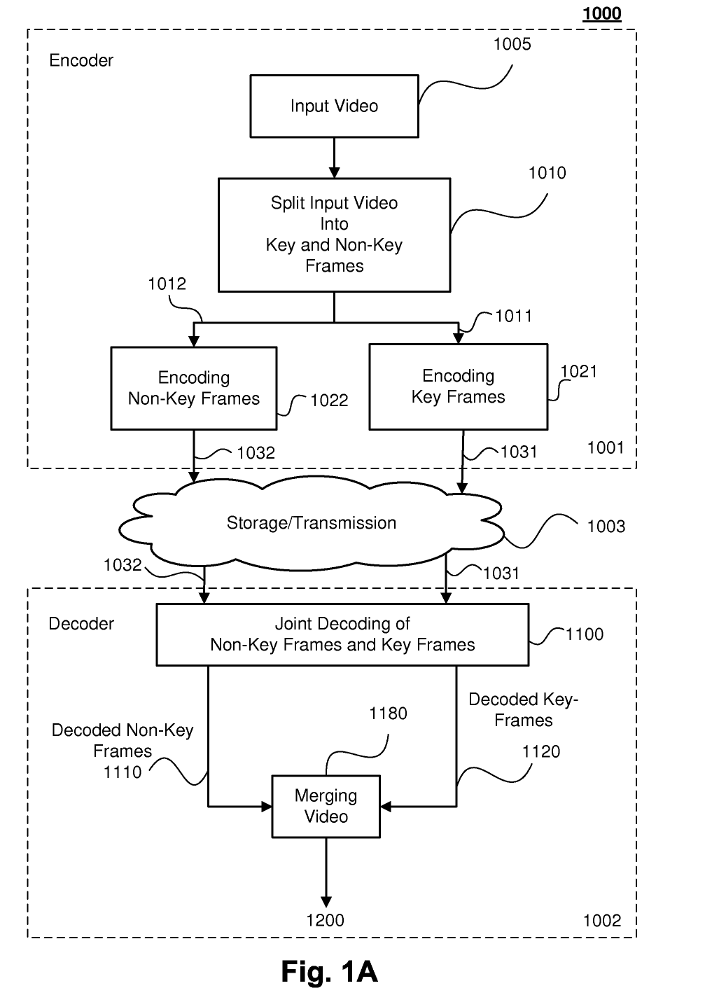

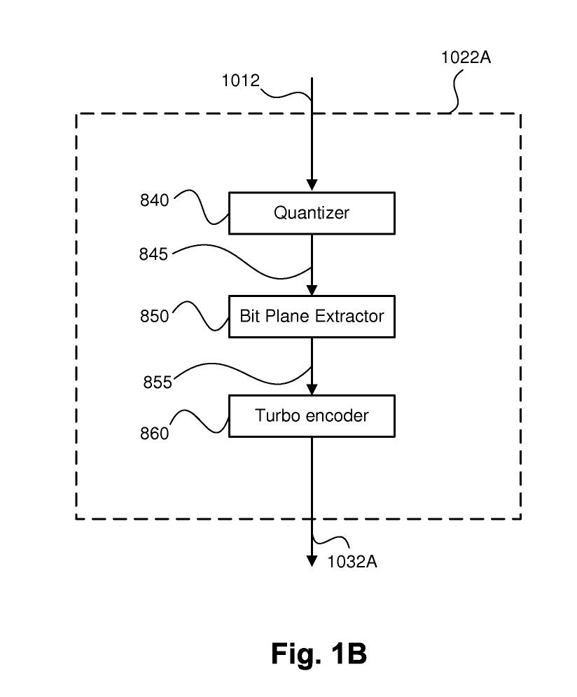

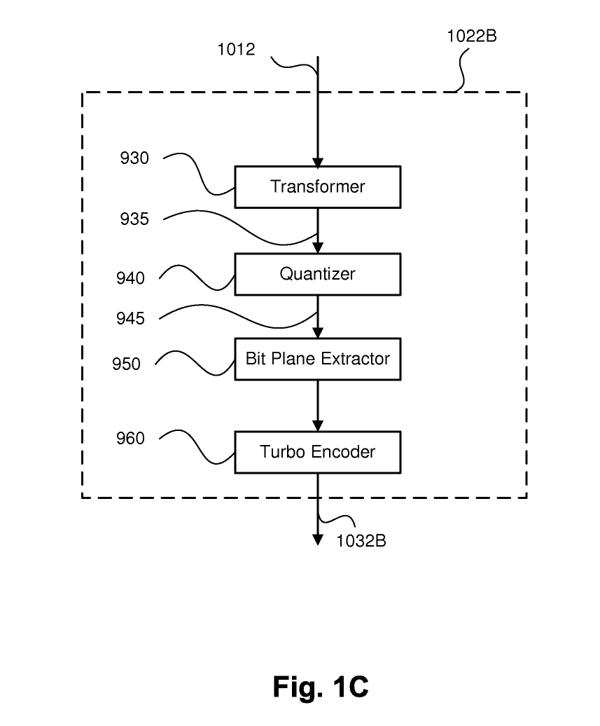

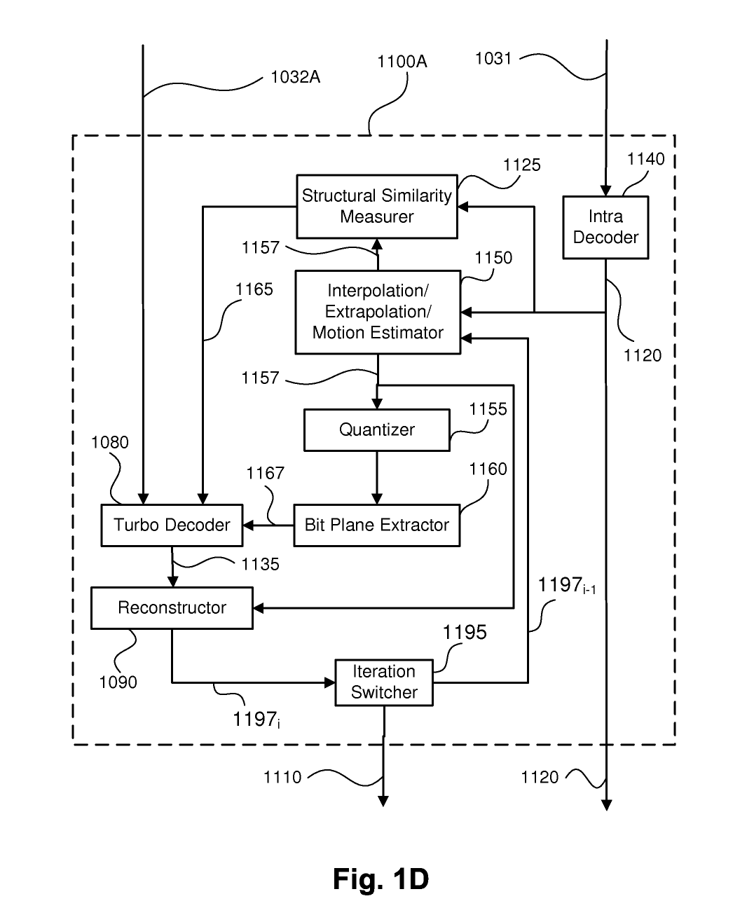

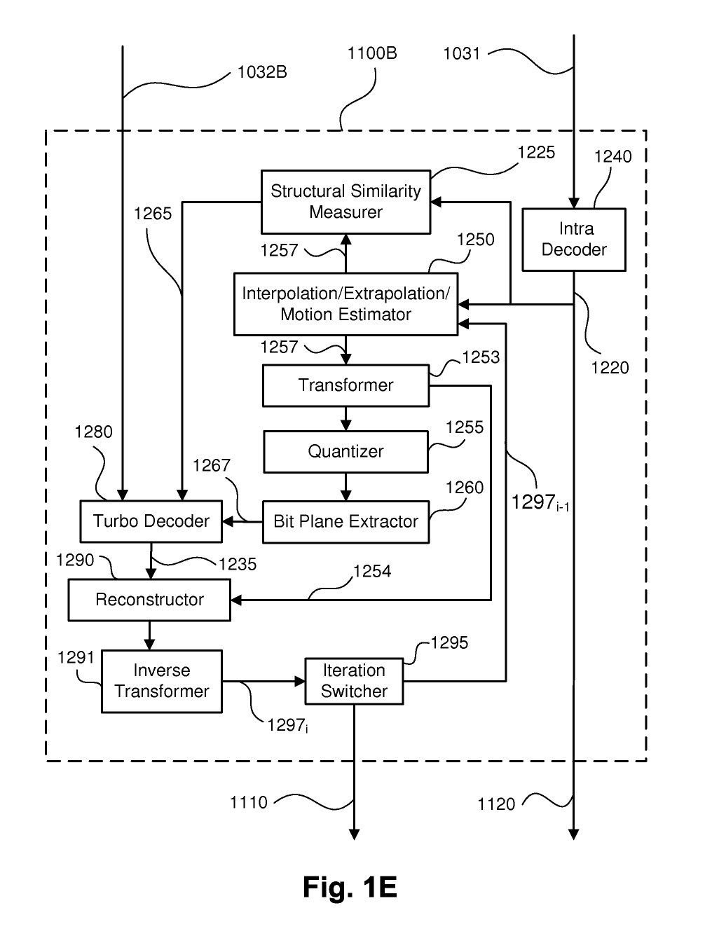

FIG. 1A shows a system 1000 for encoding an input video 1005, for storing or transmitting the encoded video, and for decoding the encoded video. The system 1000 includes an encoder 1001 and a decoder 1002 connected through a storage or transmission medium 1003.

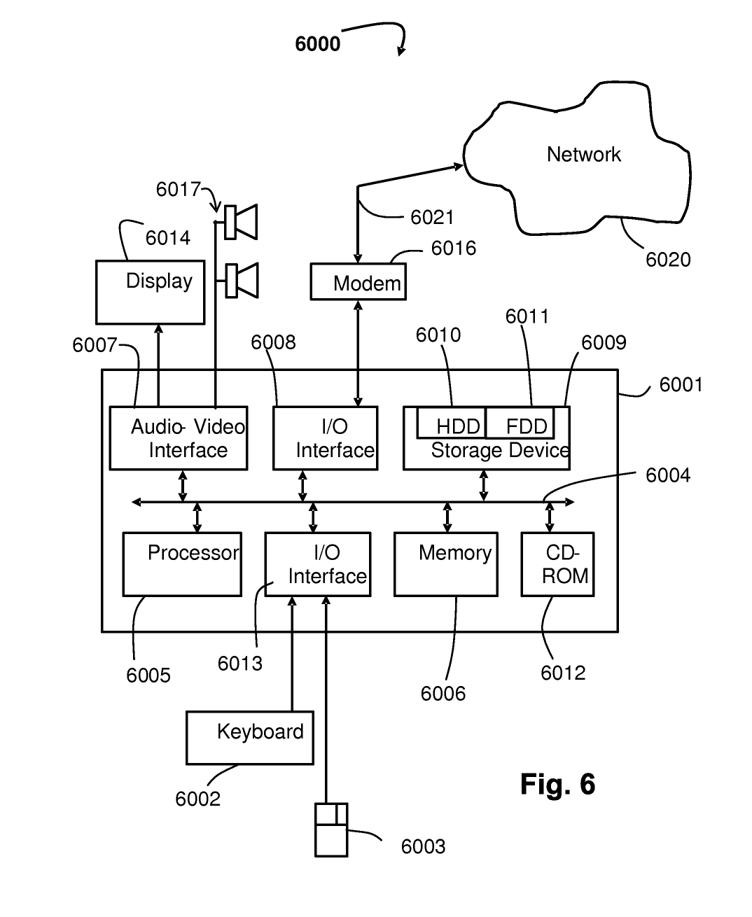

The components 1001, 1002 and 1003 of the system 1000 may be implemented using a computer system 6000, such as that shown in FIG. 6, wherein the encoder 1001 and decoder 1002 may be implemented as software, such as one or more application programs executable within the computer system 6000. The software may be stored in a computer readable medium, including the storage devices described below, for example. The software is loaded into the computer system 6000 from the computer readable medium, and then executed by the computer system 6000. A computer readable medium having such software or computer program recorded on it is a computer program product.

As shown in FIG. 6, the computer system 6000 is formed by a computer module 6001, input devices such as a keyboard 6002 and a mouse pointer device 6003, and output devices including a display device 6014 and loudspeakers 6017. An external Modulator-Demodulator (Modem) transceiver device 6016 may be used by the computer module 6001 for communicating to and from a communications network 6020 via a connection 6021.

The computer module 6001 typically includes at least one processor unit 6005, and a memory unit 6006. The module 6001 also includes a number of input/output (I/O) interfaces including an audio-video interface 6007 that couples to the video display 6014 and loudspeakers 6017, an I/O interface 6013 for the keyboard 6002 and mouse 6003, and an interface 6008 for the external modem 6016. In some implementations, the modem 6016 may be incorporated within the computer module 6001, for example within the interface 6008. A storage device 6009 is provided and typically includes a hard disk drive 6010 and a floppy disk drive 6011. A CD-ROM drive 6012 is typically provided as a non-volatile source of data.

The components 6005 to 6013 of the computer module 6001 typically communicate via an interconnected bus 6004 and in a manner which results in a conventional mode of operation of the computer system 6000 known to those in the relevant art.

Typically, the application programs discussed above are resident on the hard disk drive 6010 and are read and controlled in execution by the processor 6005. Intermediate storage of such programs and any data fetched from the network 6020 may be accomplished using the semiconductor memory 6006, possibly in concert with the hard disk drive 6010. In some instances, the application programs may be supplied to the user encoded on one or more CD-ROM and read via the corresponding drive 6012, or alternatively may be read by the user from the network 6020. Still further, the software can also be loaded into the computer system 6000 from other computer readable media. Computer readable media refers to any storage medium that participates in providing instructions and/or data to the computer system 6000 for execution and/or processing.

The system 1000 shown in FIG. 1A may alternatively be implemented in dedicated hardware such as one or more integrated circuits. Such dedicated hardware may include to Field-programmable gate array (FPGA), application-specific integrated circuit (ASIC), graphic processors, digital signal processors, or one or more microprocessors and associated memories.

In one implementation encoder 1001 and a decoder 1002 are implemented within a camera (not illustrated), wherein the encoder 1001 and the decoder 1002 may be implemented as software being executed by a processor of the camera, or may be implemented using dedicated hardware within the camera.

In a second implementation, only the encoder 1001 is implemented within a camera, wherein the encoder 1001 may be implemented as software executing in a processor of the camera, or implemented using dedicated hardware within the camera.

Referring again to FIG. 1A, as in conventional video compression techniques, which include Motion JPEG/JPEG2000, MPEG1, MPEG2, MPEG4, and H.264 compression standards, an input video 1005 is split by a frame splitter 1010 into key frames 1011 and non-key frames 1012. Typically, every second frame is a key frame. The key frames 1011 and the non-key frames 1012 are encoded in component encoding modules 1021 and 1022 respectively.

Encoded key-frames 1031 and encoded non-key frames 1032 are stored or transmitted using the storage or transmission medium 1003. The decoder 1002 receives both the encoded key-frames 1031 and the encoded non-key frames 1032. A joint decoder 1100 decodes the key-frames 1031 independently using a conventional video decoder, while the non-key frames 1032 are decoded by generating an approximation from the decoded key frames and applying parity information to correct the approximation. The decoded key-frames 1120 and decoded non-key frames 1110 are merged together in a merger 1180 to form output video 1200 comprising a sequence of decoded key frames and decoded non-key frames.

The encoding of frames 1011 and 1012 is now described in greater detail. The encoding of the key frames 1011 is first described, followed by a description of encoding of the non-key frames 1012.

In the exemplary implementation, the key frame encoding module 1021 uses conventional compression schemes such as H.264 Intra to encode the key frames 1011. In H.264 Intra mode, each frame is divided into one or multiple slices. Each slice consists of macro-blocks, which are blocks of 16×16 luminance samples. Macro-blocks may be subdivided into sub-macro-blocks, with each sub-macro-block having a size of 16×16, 8×8 or 4×4 samples. All pixels of a block are predicted from block edge pixels.

In an alternative implementation the key frame encoder module 1021 employs the JPEG compression standard. There are various video encoding formats known loosely as “Motion JPEG”. Motion JPEG encodes each frame of a video as a still image using JPEG, and provides a compressed video stream format for wrapping all the encoded frames of a video into a Motion JPEG encoded stream.

In yet another alternative implementation the key frame encoder module 1021 uses Motion JPEG2000 to encode the key frames 1011. Motion JPEG2000 encodes each frame of a video as a still image using the JPEG2000 standard. It provides a compressed video stream format for wrapping all the encoded frames of a video into a Motion JPEG2000 encoded stream.

Having described the encoding of the key frames 1011, the encoding of non-key frames 1012 performed in the non-key frame encoder module 1022 is described next with reference to FIGS. 1B and 1C, where schematic flow diagrams of the steps performed by the encoder module 1022 are shown.

FIG. 1B shows a schematic flow diagram for an encoder module 1022A to encoding non-key frames in the pixel domain. The encoder module 1022A takes non-key frames 1012 as its input. Inside the module 1022A the non-key frames 1012 are first quantized by a quantizer module 840. Desirably, a uniform quantizer is used to quantize each image pixel value of the non-key frame 1012 to a set of quantized pixels 845. In an alternative implementation, pixel values may be quantized by a nonlinear function which takes advantages of human visual system.

The quantizer module 840 is followed by a bit plane extractor module 850 where each non-key frame 1012 represented by quantized pixels 845 is converted to a bit stream. Preferably, the bit plane extractor 850 starts scanning on the most significant bit plane of the quantized pixels 845 and concatenates the most significant bits of the quantized pixels 845 to form a bit stream containing the most significant bits. In a second pass, the bit plane extractor module 850 concatenates the second most significant bit plane of the quantized pixels 845. The bits from the second scanning path are appended to the bit stream generated in the previous scanning path. The bit plane extractor module 850 continues the scanning and appending in this manner until the least significant bit plane is completed, so as to generate a bit stream 855 for each non-key frame 1012.

The bit stream 855 is then input into a turbo encoder module 860 to produce a bit stream 1032A which contains parity information for error correction at the decoder 1002 (FIG. 1A). The turbo encoder module 860 encodes the input bit stream 855 according to a bitwise error correction method. For each bit plane of the non-key frame 1012, parity bits are generated. Accordingly, if the bit depth of the quantized pixel value is eight, then eight sets of parity bits are produced, of which each parity bit set refers to one bit plane only. The parity bits output by the turbo encoder module 860 are transmitted via the storage/transmission medium 1003 in the bit stream 1032A.

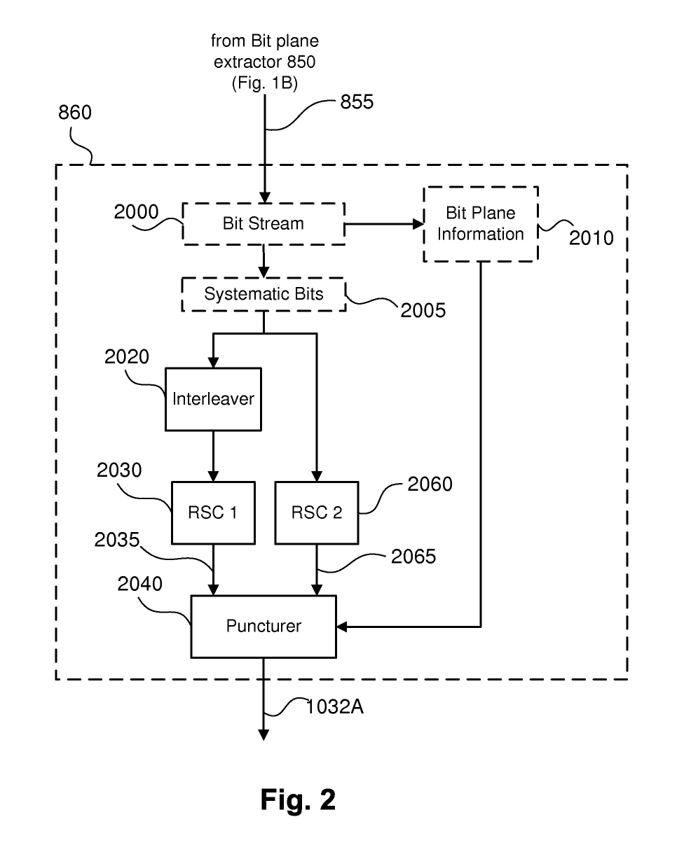

The operation of the turbo encoder 860 will be described later with reference to FIG. 2.

FIG. 1C shows a schematic flow diagram for an encoder module 1022B for encoding non-key frames in the transform domain. Here, the encoder module 1022B takes non-key frames 1012 as its input. Inside the module 1022B, the non-key frames 1012 are first processed by a transformer module 930. The transformer module 930 converts pixel values of each non-key frame 1012 to a set of transform coefficients 935.

In a first implementation, the transformation used by the transformer module 30 is the 2-D transformation defined by the H.264 Intra mode. According to the H.264 Intra mode, the non-key frame 1012 is tiled in a plurality of blocks, each block comprising of 4×4 pixels. Each 4×4 block of pixels is then 2-D transformed into a 4×4 block of transform coefficients. The transform coefficient 935 is then quantized in a quantizer module 940 according to the quantization process defined in the H.264 Intra mode. The DC coefficient and the AC coefficients of each 4×4 coefficient block are quantized independently. The quantization parameter may be different for each 4×4 block.

In a second implementation, the transformation used in the transformer 930 is a Discrete Cosine Transform (DCT). According to the JPEG compression scheme, the non-key frame 1012 is tiled in a plurality of blocks, each block comprising 8×8 pixels. Each 8×8 block of pixels is then discrete cosine transformed into an 8×8 block of DCT coefficients. Each single 8×8 DCT coefficient output from the transformer module 930 is quantized in the quantizer module 940 according to JPEG compression standard. The quantization step involves dividing each of the 8×8 DCT coefficients with a corresponding quantization factor in an 8×8 quantization matrix, and the result is rounded to the nearest integer.

The quantized coefficients 945 output by the quantizer module 940 are input to a bit plane extractor module 950 where each non-key frame 1012 is turned into a bit stream. Desirably, the bit plane extractor module 950 begins with extracting coefficient of the same spatial position from all the coefficient blocks of the coefficients 945 and concatenating the extracted coefficients together to form a coefficient band. Then, for each coefficient band, the extractor module 950 starts scanning on the most significant bit plane of the coefficient band and concatenates the most significant bits of the coefficient band to form a bit stream containing the most significant bits. In a second pass, the bit plane extractor module 950 concatenates the second most significant bit plane of the coefficient band. The bits from the second scanning path are appended to the bit stream generated in the previous scanning path. The bit plane extractor 950 continues the scanning and appending in this manner until the least significant bit plane is completed. The process repeats for each coefficient band and consequently generates one bit stream for each non-key frame.

The bit stream output from the bit plane extractor 950 is then encoded by a turbo encoder module 960 to produce the bit stream 1032B containing parity information for error correction at the decoder 1002 (FIG. 1A). The turbo encoder module 960 is substantial identical to the turbo encoder module 860 in FIG. 1B. The parity bits output by the turbo encoder 960 are then transmitted via the storage/transmission medium 1003 in the bit stream 1032B.

The turbo encoder module 860 in FIG. 1B is now described in greater detail with reference to FIG. 2 where a schematic block diagram of the turbo encoder 860 is shown.

The turbo coder 860 receives as input the bit stream 855 from the bit plane extractor module 850. In FIG. 2, the received bit stream is represented as a bit stream unit 2000 from which systematic bits 2005 and bit plane information 2010 are extracted. Inside the encoder 860 an interleaver 2020 interleaves the systematic bit set 2005 contained in the bit stream 2000 (i.e. the information bit stream). In a first implementation this interleaver 2020 is an algebraic interleaver. In alternative implementations, any other interleaver known in the art, for example a block interleaver, a random or pseudo-random interleaver, or a circular-shift interleaver, may be used.

The output from the interleaver 2020 is an interleaved systematic bit set, which is passed on to a recursive systematic coder (RSC) module 2030 which produces parity bits 2035. One parity bit per input bit is produced. Preferably the recursive systematic coder module 2030 generates parity bits using the octal generator polynomials 7 (binary 111₂) and 5 (binary 101₂).

The turbo encoder module 860 also includes a second recursive systematic coder module 2060 which operates directly on the systematic bit set 2005 extracted from the bit stream 2000 to produce parity bits 2065. Typically the recursive systematic coder modules 2030 and 2060 are substantially identical. Both recursive systematic coder modules 2030 and 2060 output a corresponding parity bit set to a puncturer module 2040. Each parity bit set is equal in length to systematic bit set 2005 in the bit stream 2000.

The puncturer module 2040 deterministically deletes parity bits to reduce the parity bit overhead generated by the recursive systematic coder modules 2030 and 2060. Typically, so called half-rate codes are employed, which means that half the parity bits from each recursive systematic encoder module 2030 and 2060 are punctured. In an alternative implementation, the puncturer module 2040 may depend on additional information, such as the bit plane information 2010 which is associated with the systematic bits 2005 in the input bit stream 2000. In yet another alternative implementation, the scheme employed by the puncturer module 2040 may depend on the spatial location of the pixel to which the information bit belongs, as well as the frequency content of the area around this pixel.

The turbo encoder module 860 produces as output a punctured parity bit stream 1032A, which comprises parity bits produced by both recursive systematic coder modules 2060 and 2030. This completes the detailed description of encoding both the key frames 1011 and the non-key frames 1012 in the encoder 1001.

In the following the joint decoding of both the encoded key frames 1031 and the encoded non-key frames 1032, as performed in the joint decoder module 1100, is described in detail with reference to FIGS. 1D and 1E where schematic block diagrams of the joint decoder module 1100 are shown.

FIG. 1D shows a schematic flow diagram of the steps performed by the joint decoder module 1100A which is used to decode bit streams produced by the encoder module 1022A in FIG. 1B. In FIG. 1D, the joint decoder module 1100A takes two encoded bit streams 1031 and 1032A from the storage/transmission medium 1003. The decoding process is performed iteratively until given termination criteria are met. The outputs from the decoder module 1100 are the decoded key frames 1120 and decoded non-key frames 1110.

At the first iteration, the encoded key-frames are retrieved from the encoded bit stream 1031 and decoded in an intra decoder module 1140, which is conventional and performs the inverse operation to the conventional encoding module 1021. The output of the decoder module 1140 comprises decoded key frames 1120.

In the next step, the decoded key frames 1120 are supplied to an estimator module 1150 where the adjacent (decoded key or non-key) frames are used to produce an estimate or approximation of the current non-key frame 1157 to be decoded (i.e. the predicted non-key frame). Techniques to obtain such an estimate or approximation may include any low complexity motion estimation, any full motion estimation, any multi-frame motion estimation, and sub-motion estimation as they are described in the literature in the art. Alternative methods can be from the vast field of interpolations and from the vast field of extrapolations, or any permutation or combination of motion estimation, interpolation and extrapolation.

The data produced by the estimator module 1150 is supplied to a quantizer module 1155 which is substantially identical to the quantizer module 840 in the encoding module 1022A of FIG. 1B. The output of the quantizer 1155 is further processed in a bit plane extractor module 1160 to generate a bit stream for each non-key frame. The plane extractor module 1160 is substantially identical to the bit plane extractor 850 of FIG. 1B. The output of the bit plane extractor module 1160 is the systematic bits 1167 of the non-key frame 1012.

The joint decoding module 1100 includes a structural similarity measuring module 1125. The structural similarity measuring module 1125 takes two inputs. The first is the output of the estimator module 1150, namely the predicted non-key frame 1157. The second is the adjacent key frames 1120 output from the intra decoder module 1140. The output of the module 1125 comprises structural similarity measures 1165 for pixel values of the predicted non-key frame 1157.

Preferably, the structural similarity measuring module 1125 processes the predicted non-key frame 1157 in a block-by-block basis, where the block dimension may be identical to the one used by the motion estimation in the estimator module 1150. For each block of the predicted non-key frame 1157, the module 1125 first locates two closest reference blocks in the adjacent key frames 1120. The “closeness” is measured against a distortion criterion which may be identical to the one used in the estimator module 1150. The structural similarity of the two reference blocks is then measured. The reference block size may need to enlarge further to produce another set of structural similarity measures. The structural similarity between each block and its eight-neighbour blocks in the predicted non-key frame 1157 may also be measured.

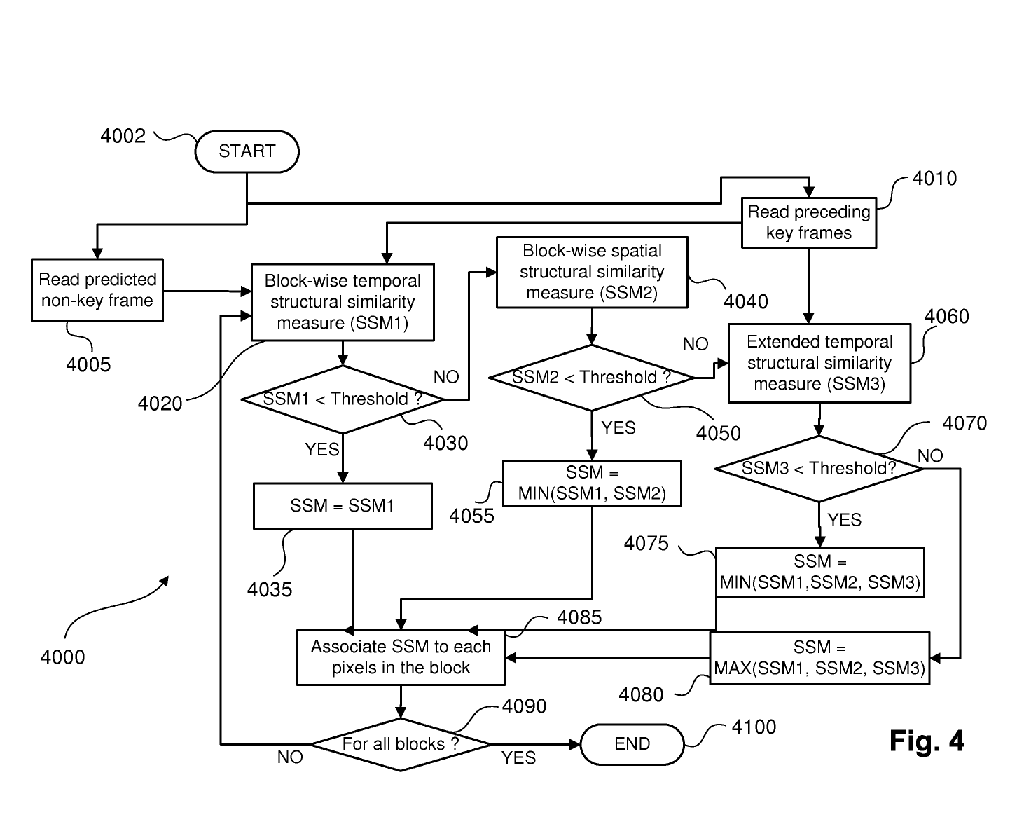

The details of the structural similarity measuring module 1125 will be described later with reference to FIG. 4.

Inside the joint decoder module 1100A, the input bit stream 1032A is decoded by a turbo decoder module 1080 with the help of two additional data sets. The first additional data set is the systematic bits 1167 output from the bit plane extractor module 1160. The second additional data set is the structural similarity measures 1165. The turbo decoder module 1080 uses the parity information from the bit stream 1032A to correct the prediction error in the predicted non-key frame 1157 to generate a decoded bit stream 1135 which represents a better prediction of the non-key frame 1012.

The turbo decoder module 1080 operates on each bit plane of the input bit stream 1032A in turn to correct at least a portion of that (current) bit plane. In a first iteration, the turbo decoder module 1080 receives the parity bits for the first (most significant) bit plane from bit stream 1032A as input. The turbo decoder module 1080 also receives the first bit plane from the bit stream output from the bit plane extractor module 1160 as systematic bits. The turbo decoder module 1080 uses the parity bits for the first bit plane to improve the approximation (or determine a better approximation) of the first bit plane of the non-key frame 1012 according to the structural similarity measures 1165 computed by the module 1125. The turbo decoder module 1080 outputs a decoded bit stream representing a decoded first bit plane. The above process repeats for lower bit planes until all bit planes are decoded.

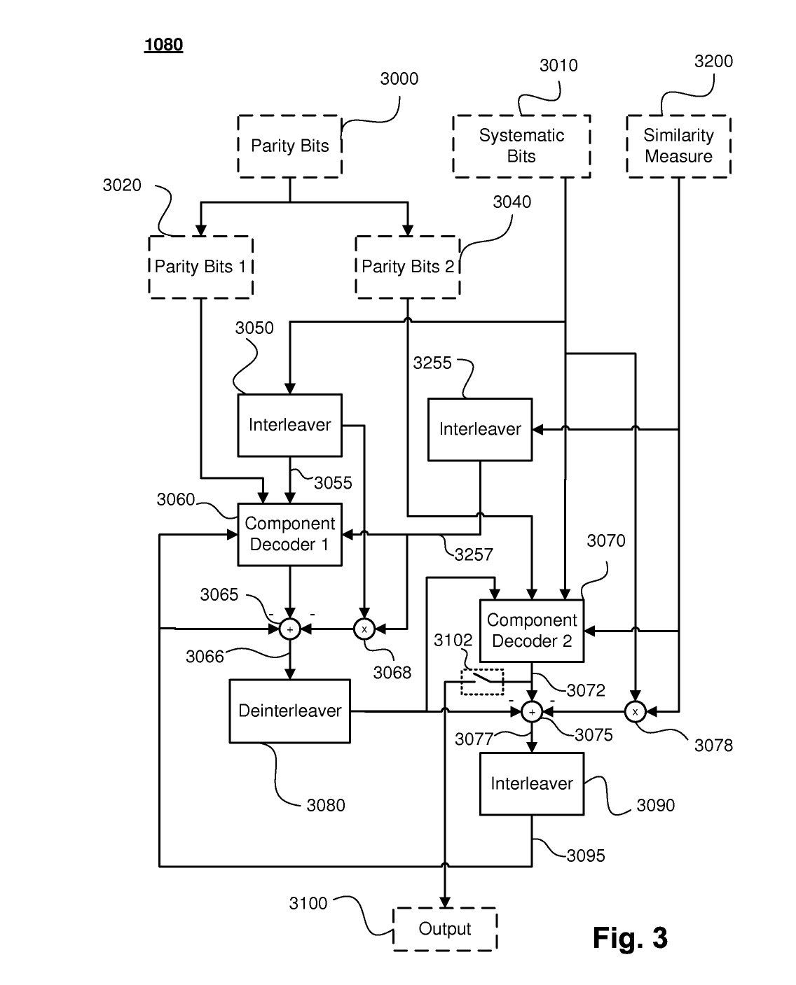

Details of the steps performed in the turbo decoder module 1080 will be described later with reference to FIG. 3.

Still referring to FIG. 1D, the joint decoder module 1100A includes a reconstruction module or reconstructor 1090 which is directly connected to an output 1135 from the turbo decoder module 1080. The reconstruction module 1090 performs the step of reconstructing pixel values of the non-key frame 1012 from the decoded bit stream 1135. In the exemplary implementation, the most significant bits of the pixel data of the non-key frame 1012 are first determined by the reconstruction module 1090. The second most significant bits of the pixel data of the non-key frame 1012 are then determined and concatenated with the first most significant bits of the pixel data of the non-key frame 1012. This process repeats for lower bit planes until all bits are determined for each bit plane of the non-key frame 1012. Finally, the reconstruction module 1090 performs an inverse operation of the quantizer module 1155 to reconstruct the pixel values. An output 1197 from the reconstruction module 1090 represents a final approximation of the original non-key frame 1012 for the current iteration. This is designated in FIG. 1D as the output 1197ᵢ.

The decoder module 1100A further includes an iteration switcher module 1195 which receives the output 1197ᵢ from the reconstruction module 1090. The iteration switcher module 1195 controls the joint decoding process based on termination criteria. When the criteria are met, the iterative joint decoding process is terminated and the reconstructed non-key frame 1197ᵢ is output as the decoded non-key frame 1110. Otherwise, the iterative joint decoding process continues. The criteria used to determine the termination of the iterative joint decoding process includes (but need not be limited to) the number of iterations performed, or the difference of the reconstructed non-key frame 1197 between two successive joint decoding iterations, or both.

When a further joint decoding iteration is required, the reconstructed non-key frame 1197 is used as side information for the next decoding iteration.

The next iteration of the joint-decoding process starts with the estimator module 1150. In this iteration the estimator module 1150 takes two inputs instead of one. Besides taking the decoded key frames 1120 from the conventional decoder module 1140, the estimator module 1150 also takes as input the reconstructed non-key frame 1197 from the previous iteration, denoted in FIG. 1D as non-key frame 1197ᵢ₋₁. The estimator module 1150 outputs a refined prediction of the original non-key frame 1012 based on motion estimation and/or motion interpolation.

The motion estimation in the second iteration is performed between the reconstructed non-key frame 1197ᵢ₋₁, and at least one of the adjacent (decoded key or non-key) frames which were used by the estimator module 1150 in the previous joint decoding iteration. The estimation can be based on forward motion, backward motion, or bidirectional motion. Techniques to obtain this estimate may be substantial identical to the one used by the estimator 1150 in the previous joint decoding iteration, which may include any low complexity motion estimation, any full motion estimation, any multi-frame motion estimation, and sub-motion estimation as they are described in the literature in the art. Alternative methods can be from the vast field of interpolations and from the vast field of extrapolations or any permutation or combination of motion estimation, interpolation and extrapolation.

In the next step, the predicted non-key frame 1157 output from the estimator module 1150 is input into the structural similarity measuring module 1125 to generate a refined version of structural similarity measures 1165. In the exemplary embodiment, the module 1125 in the second iteration (or beyond) operates substantially identical to its operation in the first iteration of joint decoding. However, in an alternative implementation (not illustrated), the reconstructed non-key frame 1197ᵢ₋₁ may input into the structural similarity measuring module 1125 to improve the similarity measuring for the predicted non-key frame 1157.

The operations performed by the quantizer module 1155, the bit plane extractor module 1160, the turbo decoder module 1080, and the reconstruction module 1090 in this decoding iteration are substantially identical to that of the previous decoding iteration. The current decoding iteration generates a refined version of approximated non-key frame 1197 as the reconstruction of the non-key frame 1012.

The aforementioned iterative joint decoding process continues until the iteration switcher module 1195 determines that the current reconstructed non-key frame 1197 has met the criteria to become the decoded non-key frame 1110. This completes the detailed description of the joint decoder module 1100 in Fig. D.

FIG. 1E shows a schematic flow diagram of the steps performed by the joint decoder module 1100B which is used to decode bit streams produced by the encoder module 1022B in FIG. 1C.

In FIG. 1E, the joint decoder module 1100B takes two encoded bit streams 1031 and 1032B from the storage/transmission medium 1003. The decoding process is performed iteratively until given termination criteria are met. The outputs from the decoder module 1100 are the decoded key frames 1120 and decoded non-key frames 1110.

In the first iteration, the encoded key-frames are retrieved from the encoded bit stream 1031 and decoded in an intra decoder module 1240, which is conventional and performs the inverse operation to the conventional encoding module 1021. The outputs of the decoder module 1240 are the decoded key frames 1220.

In the next step, the decoded key frames 1220 are supplied to an estimator module 1250 where the adjacent (decoded key or non-key) frames are used to produce a prediction 1257 of the current non-key frame 1012. In an exemplary implementation, the estimator module 1250 is substantially identical to the estimator module 1150 described in FIG. 1D.

The predicted frame 1257 from the estimator module 1150 is supplied to a transformer module 1253 where pixel values of the predicted frame are converted to transform coefficients. The transformer module 1253 is substantially identical to the transformer module 930 in the encoder module 1022B of FIG. 1C. The transform coefficients are then quantized by a quantizer module 1255 which is substantially identical to the quantizer module 940 in the encoder module 1022B of FIG. 1C. The output of the quantizer 1255 is further processed in a bit plane extractor module 1260, where systematic bits 1267 are generated for each non-key frame 1012 by performing the same operations as the bit plane extractor module 950 of FIG. 1C.

The joint decoding module 1100B includes a structural similarity measuring module 1225, where the structural similarity for pixel values of the predicted non-key to frame 1257 is computed based on the adjacent key frames 1220 output by the intra decoder 1240. Desirably, the structure similarity measuring module 1225 is substantially identical to the structure similarity measuring module 1140 in Fig. D.

In the next step, the turbo decoder module 1280 applies parity bits to correct the errors in the prediction of the current non-key frame 1012. The turbo decoder 1280 takes three inputs: the systematic bits 1267 from the bit plane extractor module 1260, the parity bits from the input bit stream 1032B, and the structural similarity measures 1265. The turbo decoder 1280 outputs a decoded bit stream representing a better prediction of the non-key frames 1012. Typically, the turbo decoder module 1280 is substantially identical to the turbo decoder module 1080 of FIG. 1D.

The joint decoder module 1100B further includes a reconstruction module or reconstructor 1290 which is directly connected to the turbo decoder module 1280. The reconstruction module 1290 receives two inputs. The first input is the decoded bit stream 1235 from the turbo decoder module 1280. The second input is the transform coefficients 1254 produced by the transformer module 1253. In the reconstruction module 1290 these two sets of input are compared. In an exemplary implementation, a coefficient from the first input set is compared to the coefficient from the same pixel location of the second input set. If this difference is sufficiently small then the resulting coefficient for this pixel location is set to be equal to the coefficient from the second input set. If this difference is large then the resulting coefficient equals the coefficient from the first input set. The output the reconstruction module 1290 is supplied to an inverse transformer module 1291 where an inverse transformation of the operations performed in the transformer module 930 of FIG. 1C is applied. The output of the inverse transformer module 1291 is the first iteration reconstruction 1297ᵢ of the original non-key frame 1012.

The decoder module 1100B further includes an iteration switcher module 1295 which is connected to the inverse transformer module 1291. Desirably the iteration switcher module 1295 is substantially identical to the iteration switcher module 1195 of FIG. 1C.

When a further joint decoding iteration is required, the reconstructed non-key frame 1297ᵢ is used as side information for the next decoding iteration.

In the second iteration or beyond, the approximated non-key frame 1297 from the previous iteration, denoted as frame 1297ᵢ₋₁ in FIG. 1E, is input into the estimator module 1250 for another motion estimation process. In the exemplary embodiment the estimator 1250 in this iteration is substantially identical to the estimator 1150 of FIG. 1D which operated in the second iteration or beyond. The output of the estimation in this iteration is a refined prediction of the original non-key frame 1012.

In the next step, the predicted non-key frame 1257 output from the estimator module 1250 is input into the structural similarity measuring module 1225 to generate a refined version of structural similarity measures 1265. In an exemplary implementation, the module 1225 in the second iteration (or beyond) operates substantially identical to its operation in the first iteration of joint decoding.

The operations performed by the transformer module 1253, the quantizer module 1255, the bit plane extractor module 1260, the turbo decoder module 1280, the reconstruction module 1290, and the inverse transformer module 1291 in this decoding iteration are substantially identical to that of the previous decoding iteration. The current decoding iteration generates a refined version of 1297 as the reconstruction of the non-key frame 1012.

The aforementioned iterative joint decoding process continues until the iteration switcher module 1295 determines that the current reconstructed non-key frame 1297 has met the criteria to become the decoded non-key frame 1110. This completes the detailed description of the joint decoder module 1100B in Fig. E.

Having described the joint decoder 1100A, the structural similarity measuring module 1125 within the joint decoder 1100 is now described in further detail with reference to FIG. 4 where a schematic flow diagram of the processing 4000 performed by structural similarity measuring module 1125 is shown.

In the exemplary implementation, the structural similarity measure (SSM) between two blocks, a and b, is given by

$$SSM ( a , b ) = \frac{( 2 {μ}_{a} {μ}_{b} + {C}_{1} )}{( {μ}_{a}^{2} + {μ}_{b}^{2} + {C}_{1} )} \cdot \frac{( 2 {σ}_{ab } + {C}_{2} )}{( {σ}_{a}^{2} + {σ}_{b}^{2} + {C}_{2} )} \qquad ( 1 )$$

where μₐ and μ_{b} are the local mean of the two block, respectively; σₐ and σ_{b} are the local standard deviation of the two blocks, respectively; and σ_{ab} is the cross deviation between the two blocks; C₁ and C₂ are small positive constants such as C₁=6.5 and C₂=58.5;

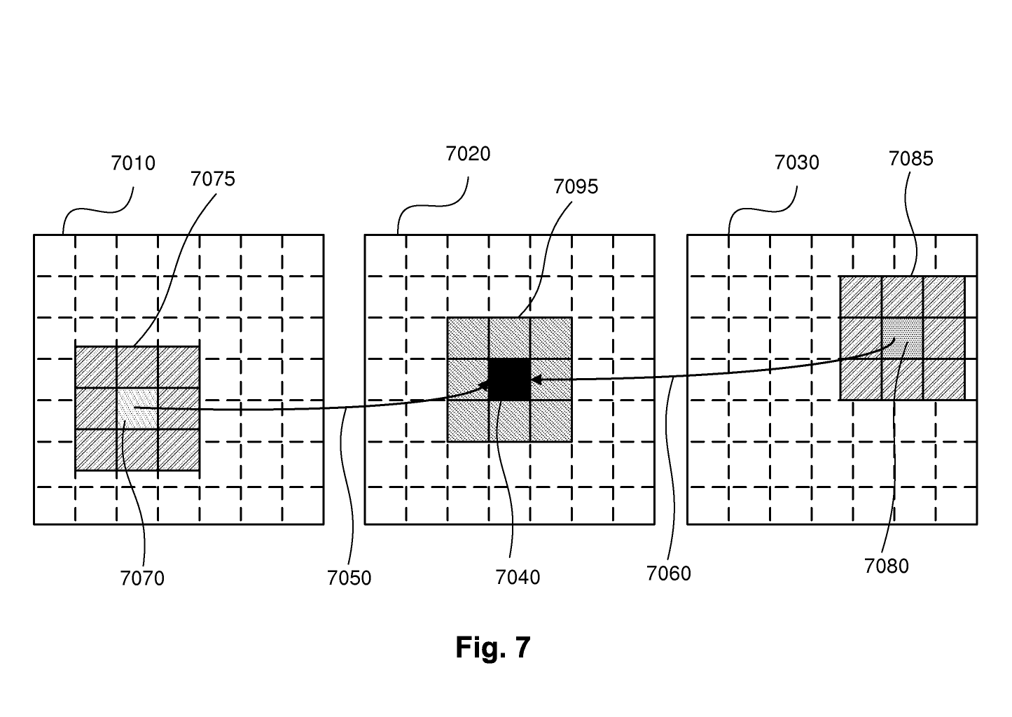

The structural similarity measure processing 4000 starts from step 4002. In step 4005 the predicted non-key frame, or the current frame, is read from the estimator 1150 (FIG. 1D), simultaneously in step 4010 the adjacent key frames, or the reference frames, (which were used by the estimator 1150 to predict the current frame) are read. FIG. 7 shows one of the example of the current and the reference frames, where 7020 is the current frame (or the predicted non-key frame), and 7010 and 7030 are the two reference frames from which the 7020 is predicted based on motion information.

A first similarity measure is performed in step 4020. This similarity measure is conducted between a block in the current frame, and its associated blocks in the reference frames. FIG. 7 gives an example of such blocks where block 7040 is the block to be measured (or the current block) in the current frame 7020, and blocks 7070 and 7080 are the blocks which are associated with the current block 7040 by the forward motion vector 7050 and the backward motion vector 7060, respectively. These two blocks are the reference blocks of the block 7040. The SSM between the current block and each of its reference blocks is then computed using the equation (1). The maximum value of these SSM is selected as the output of the step 4020, namely SSM1.

In the next step 4030, SSM1 is compared against a threshold. The threshold is a fractional value sitting between 0 and 1 to determine whether the current block under measuring is substantially similar to its reference blocks or not. In a preferred implementation, the threshold value is predetermined offline, based on the statistics distribution of SSM and the motions of the non-key frames of a training video sequence. In an alternative implementation, the threshold value for the current frame 7020 is determined on-the-fly, based on the statistics distribution of the SSM and the motions of the previously processed non-key frames.

If SSM1 is smaller than the threshold in the step 4030, the current block 7090 is determined to be significantly different from its reference blocks 7070 and 7080 (FIG. 7). Hence the similarity measure for the current block is completed, and the final structural similarity measure for the current block, SSM, is assigned the value of SSM1 in step 4035.

If SSM1 is equal to or larger than the threshold, then a second similarity measure is performed in the next step 4040. Now the similarity measure is conducted spatially between the current block and its eight neighbour blocks in the current frame. FIG. 7 gives an example of these blocks where block 7040 is the current block in the frame 7020, and 7095 represents its eight neighbour blocks in the frame 7020. The similarity measure is computed between the current block and each of its eight neighbour blocks in the step 4040 using the equation (1). The maximum value of these SSM is then selected as the output of the step 4040, namely SSM2.

In the next step 4050, SSM2 is compared against a threshold. In a preferred implementation, the same threshold from the step 4030 is used. In an alternative implementation, the threshold value is determined offline, according to the statistics distribution of the SSM between a block and its eight neighbour blocks of a training video sequence. In yet another alternative implementation, the threshold value for the current frame 7020 is determined on-the-fly, according to the statistics distribution of the SSM between a block and its eight neighbour blocks in the previously processed non-key frames.

If SSM2 is smaller than the threshold in step 4050, the similarity measure for the current block is completed, and the structural similarity measure for the current block, SSM, is assigned to be the minimum of SSM1 and SSM2 in step 4055.

If SSM2 is equal to or larger than the threshold, a third similarity measure is performed in the next step 4060. Now similarity measure is conducted temporally between an extended current block, and its extended reference blocks in the reference frames. FIG. 7 gives an example of these extended blocks, where block 7040 is the current block, and blocks 7070 and 7080 are its reference blocks according to motion prediction. An extended block is defined as the block containing the current block and its eight neighbour blocks. For example, the extended block of block 7040 comprises the current block 7040 and its eight neighbour blocks 7095; the extended block of block 7070 comprises the reference block 7070 and its eight neighbour blocks 7075; and the extended block of block 7080 comprises the reference block 7080 and its eight neighbour blocks 7085.

In step 4060 the similarity measure is computed between the extended current block and each of its extended reference blocks using the equation (1). The maximum value of these SSM is then selected as the output of the step 4060, namely SSM3.

In a further step 4070, the output from the step 4060, SSM3, is compared against a threshold, where the same threshold from the step 4030 may also be used. If SSM3 is smaller than the threshold in step 4050, the final structural similarity measure for the current block, SSM, is set to be the minimum of SSM1, SSM2, and SSM3 in step 4075. Otherwise, SSM is assigned to the maximum value of SSM1, SSM2, and SSM3 in step 4080.

Finally, after determining the SSM for the current block, the resulting SSM is assigned to each pixel in the current block in step 4085. Then in step 4090 the process 4000 assesses whether all blocks in the current frame has been processed. If there are blocks to be processed, the process 4000 moves back to step 4020. Otherwise the entire process is ended at step 4100. This completes the detailed description of the steps performed by the structural similarity measuring module 1125 (FIG. 1D). As noted above, the structural similarity measurer 1225 of FIG. 1E can operate in a corresponding manner.

Now the turbo decoder 1080 within the joint decoder 1100 is described in further detail with reference to FIG. 3 where a schematic flow diagram of the turbo decoder 1080 is shown. The turbo decoder 1080 takes three inputs. The first input is the parity bits 3000 which are extracted from the received encoded bit stream 1032A (FIG. 1D); the second input is the systematic bits 3010 which are generated by the bit plane extractor 1160 (FIG. 1D); and the third input is the similarity measures 3200 which are produced by structural similarity measuring module 1125 (FIG. 1D).

The parity bits 3000 are further split into two sets of parity bits: a parity bit set 3020 which originates from the recursive systematic coder 2030 (FIG. 2), and another to parity bit set 3040 which originates from the recursive systematic coder 2060 (FIG. 2).

Parity bits 3020 are then input to a first Component Decoder 3060, which preferably employs the Max-Log Maximum Aposteriori Probability (MAP) algorithm as known in the art. In alternative implementations, the Soft Output Viterbi Decoder (SOVA), also known in the art, or variations thereof are used instead of the Max-Log MAP algorithm.

The systematic bits 3010 are passed as input to an interleaver 3050. This interleaver 3050 outputs interleaved systematic bits 3055 to the first component decoder 3060.

The similarity measures 3200 are also passed as input to another interleaver 3255 which is substantially identical to the interleaver module 3050. This interleaver 3255 provides interleaved similarity measures 3257 which are provided to the first component decoder 3060.

In a similar manner, Parity bits 3040 are input to a second Component Decoder 3070, together with the systematic bits 3010 and the similarity measures 3200.

The decoder 1080 in FIG. 3 works iteratively. A loop is formed starting from the first component decoder 3060, to a first adder 3065, to a deinterleaver 3080, to the second component decoder 3070 having an output 3072 to a second adder 3075, to an interleaver 3090 and back to the first component decoder 3060 via a connection 3095.

The processing performed in this loop is now described in more detail. The component decoder 3060 takes four inputs: the parity bits 3020; the interleaved systematic bits 3055 from the interleaver 3050; the interleaved similarity measures 3257 from the interleaver 3255; and the feedback output 3095 derived from the second component decoder 3070, having been modified in adder 3075 and interleaved in the interleaver 3090. The input from one component decoder to another component decoder provides information about the likely values of the bits to be decoded. This information is typically provided in terms of the Log Likelihood Ratios

$$L ( {u}_{k} ) = ln ( \frac{P ( {u}_{k} = + 1 )}{P ( {u}_{k} = - 1 )} ) ,$$

where P(uₖ=+1) denotes the probability that the bit uₖ equals +1 and where P(uₖ=−1) denotes the probability that the bit uₖ equals −1.

In the first iteration the feedback input 3095 from the second component decoder 3070 does not exist, and in the first iteration this input is set to zero.

The (decoded) bit sequence produced by component decoder 3060 is passed on to adder 3065 where the so-called a priori information related to the bit stream is produced. Firstly the received systematic bits 3050 are weighted by their corresponding similarity measure in a first multiplier 3068. Then, the output from the first multiplier 3068 is extracted in the first adder 3065, and the information 3095 produced by the second component decoder 3070 (which are processed analogously in adder 3075 and interleaved in interleaver 3090) are extracted as well. What left over is the a priori information 3066 which gives the likely value of a bit. This information, after being de-interleaved by the deinterleaver 3080, is valuable as a feedback input for the second component decoder 3070.

In the exemplary implementation, the exchanging of a priori information between the two component decoder modules is given by

L(uₖ)=L(uₖ|y)−wₖ^{s}yₖ^{s}−Lₑ(uₖ), (2)

where L(uₖ|y) is the soft output from the first component decoder 3060 for the decoded bit uₖ, based on the assumption that the systematic and parity bit set produces by the encoder 1000 (FIG. 1A) for uₖ is y; yₖ^{s} represent systematic bits contained in y; wₖ^{s} is the similarity measure corresponding to systematic bits yₖ^{s}, which is produced by the structural similarity measuring module 1125 (FIG. 1D); and Lₑ (uₖ) is a priori information which gives the likely value of a bit uₖ from the second component decoder 3070.

After adder 3065, the resulting bit stream 3066 is de-interleaved in deinterleaver 3080, which performs the inverse operation of interleaver 3050. The de-interleaved bit stream from deinterleaver 3080 is obtained as the feedback input to the second component decoder 3070. In the preferred implementation, the second component decoder 3070, the second multiplier 3078, and the second adder 3075 work analogously to the first component decoder 3060, the first multiplier 3068, and the first adder 3065 already described. The resulting bit stream 3077 is again interleaved in interleaver 3090 and used as the feedback input 3095 for the next iteration to the first component decoder 3060.

In an exemplary implementation, eight iterations between the first component decoder 3060 and the second component decoder 3070 are carried out. After completion of eight iterations, the resulting bit stream 3072 produced from component decoder module 3070 is selected, schematically illustrated in FIG. 3 by a switch 3102, to become the decoded output 3100.

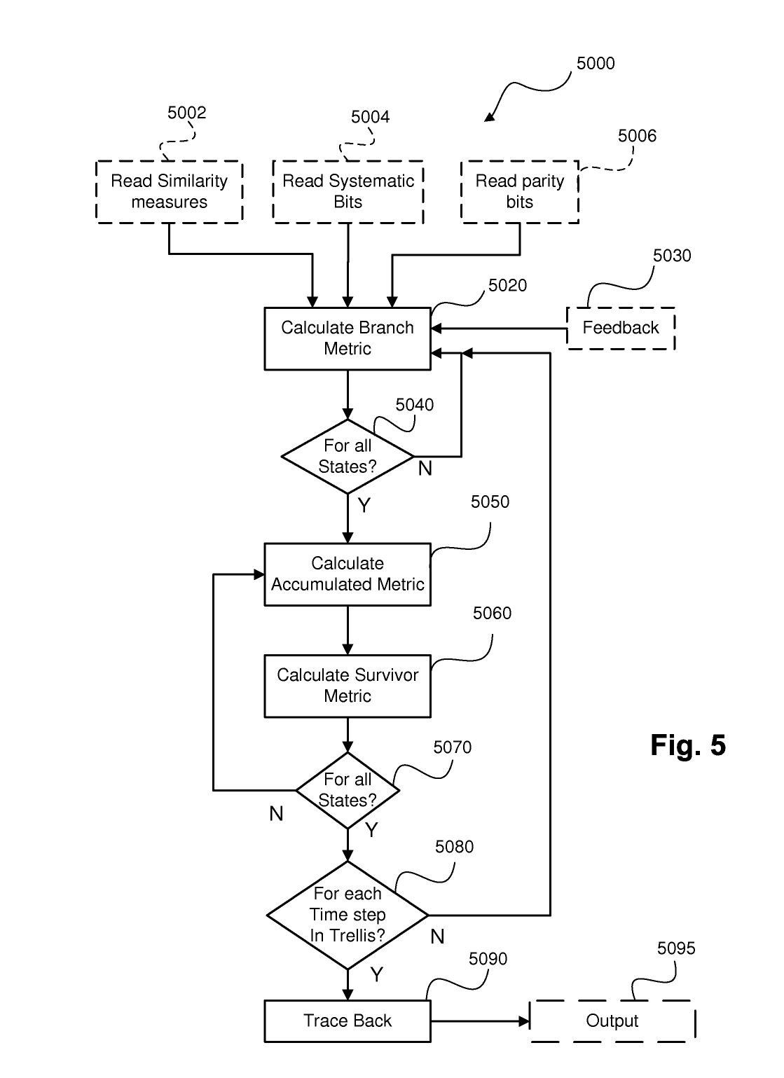

The component decoder module 3060 is now described in more detail with reference to FIG. 5 where a schematic flow diagram of the processing 5000 performed by the component decoder module 3060 is shown. Theoretically, the two component decoders 3060 and 3070 used in the turbo decoder 1080 may not be identical. However, in the exemplary embodiment, the component decoder modules 3060 and 3070 are the same.

The component decoder 3060 commences operation by simultaneously reading the systematic bits 3010 (FIG. 3) in step 5004, reading the parity bits 3000 (FIG. 3) in step 5006, and reading the similarity measures 3200 (FIG. 3) in step 5002. Processing continues in step 5020 where the so-called branch metric is computed. The branch metric is a measure for the decoding quality for the current code word and the concept thereof is well known in the art.

The computation of the branch metric is performed by getting feedback 5030 from the other component decoder module 3070 (i.e. 3095 in FIG. 3) in the form of the log likelihood ratios as already described above. The log likelihood ratios, or LLR in short, and as such the calculation of the branch metrics, are calculated with reference to the similarity measures which are associated with the systematic bits 3010 (FIG. 3). In an implementation where the SOVA algorithm is used by the component decoder 3070, the computation of the branch metric is given by:

$$M ( {s}_{k}^{s} ) = M ( {s}_{k - 1}^{s} ) + \frac{1}{2} {u}_{k} L ( {u}_{k} ) + \sum {w}_{k}^{s} {y}_{k}^{s} {x}_{k}^{s} + {w}_{p} \sum {y}_{k}^{p} {x}_{k}^{p} , \qquad ( 3 )$$

where sₖ^{s} denotes a path in the trellis diagram at stage k; sₖ₋₁^{s} denotes a path in the trellis diagram at previous stage k−1 which joins the path sₖ^{s} at stage k; M(sₖ^{s}) and M(sₖ₋₁^{s}) are the branch metric for sₖ^{s} and sₖ₋₁^{s}, respectively; L(uₖ) is the a priori LLR feedback from the other component decoder for the decoded bit uₖ; yₖ^{s} and xₖ^{s} are, respectively, the systematic bit produced by the encoder 1000 (FIG. 1A) and the systematic bit received by the turbo decoder module 1080 (FIG. 1D) for the current code word; wₖ^{s} represents the similarity measure for systematic bit xₖ^{s}, which is produced by the structural similarity measuring module 1125 (FIG. 1D); yₖ^{p} and xₖ^{p} are, respectively, the parity bit encoded by the encoder 1000 (FIG. 1A) and the parity bit received by the turbo decoder module 1080 (FIG. 1D) for the current code word; and wₚ is the weight associated with the parity bits, which is set to a fixed value as known in the art.

Referring again to FIG. 5, it is determined in the next step 5040 whether all states of a trellis diagram have been processed. If all states have not been processed, then processing returns to step 5020. If it is determined in step 5040 that the branch metrics for all states have been calculated, processing continues to step 5050 where the accumulated metric is computed. The accumulated metric represents the sum of previous code word decoding errors, which is the sum of previous branch metrics.

In step 5060 the so-called survivor path metrics are calculated. The survivor path metric represents the lowest overall sum of previous branch metrics, indicating what is the optimal decoding up to date.

Next, in step 5070 it is determined whether all states have been processed. If states remain for processing, then processing within the component decoder module 3060 returns to step 5050. Once the computation of the branch metrics, the calculation of the accumulated metric and the calculation of the survivor path metrics is completed processing continue for a next time step in the trellis diagram in step 5080. Once the survivor metric is calculated for all nodes in the trellis diagram, trace back is calculated in step 5090. The trace back operation uses the obtained knowledge of which is the best decoding metric (indicating the decoding quality) to generate the decoded bit stream. The output of step 5090 is the final output 5095 of the component decoder module 3060. This completes the detailed description of the turbo decoder module 1080.

The foregoing describes only some embodiments of the present invention, and modifications and/or changes can be made thereto without departing from the scope and spirit of the invention, the embodiments being illustrative and not restrictive.

We claim:

1. A method of decoding a frame of video data encoded in a format having a first field comprising a plurality of encoded key frames and a second field comprising data facilitating error correction of an approximation of the frame to be decoded using the first field, said method comprising the steps of:
(i) decoding at least two key frames from the first field;
(ii) determining the approximation of the frame from the decoded key frames;
(iii) determining a reliability for each of at least parts of the approximation; and
(iv) applying said data facilitating error correction to the approximation of the frame, based on the determined reliabilities for said parts to thereby form the decoded frame.

2. A method according to claim 1 wherein step (ii) comprises using frames adjacent the frame to be decoded to form the approximation of the frame.

3. A method according to claim 2 wherein the method is iterative and the frames adjacent are selected from the group consisting of a decoded key frame, and a decoded frame from a previous iteration.

4. A method according to claim 2 wherein the adjacent frames are used to estimate the frame approximation using at least one of motion estimation, interpolation and extrapolation.

5. A method according to claim 1 wherein step (iii) comprises forming structural similarity measures based upon the frame approximation and a decoded key frame.

6. A method according to claim 5 wherein the structural similarity measures are formed based upon a comparison of blocks of each of the frame approximation and the decoded key frame.

7. A method according to claim 6 further comprising forming structural similarity measures for at least two of a bock-wise temporal measure, a block-wise spatial measure and an extended temporal measure and comparing each measure with a corresponding threshold, and associating a corresponding measure with each block of the frame approximation.

8. A method according to claim 5 wherein step (iv) comprises turbo decoding the data facilitating error correction, the similarity measures and a representation of the frame approximation.

9. A method according to claim 8 wherein the data facilitating error correction comprises parity data and the representation of the frame approximation comprises systematic data extracted from the frame approximation, the similarity measures being used with the parity and systematic data for the calculation of branch metrics for use in turbo decoding.

10. A method according to claim 9 wherein a result of said turbo decoding forms the decoded frame associated with the first and second fields, and an input for step (ii) for decoding of a subsequent frame.

11. A method of decoding a non-key frame of a stream of frames of video data encoded in a format having a first field comprising a plurality of encoded key frames and a second field comprising parity data facilitating reconstruction of the non-key frame to be decoded, said method comprising the steps of:
(i) decoding at least two key frames from the first field;
(ii) determining an approximation frame from the decoded key frames;
(iii) determining a reliability for of the approximation frame; and
(iv) applying said parity data to the approximation frame, based on the determined reliability to thereby form the decoded non-key frame.

12. Apparatus for decoding a frame of video data encoded in a format having a first field comprising a plurality of encoded key frames and a second field comprising data facilitating error correction of an approximation of the frame to be decoded using the first field, said apparatus comprising the steps of:
a decoder for decoding at least two key frames from the first field;
an estimator for determining the approximation of the frame from the decoded key frames;
a measurer for determining a reliability for each of at least parts of the approximation; and
a reconstructor for applying said data facilitating error correction to the approximation of the frame, based on the determined reliabilities for said parts to thereby form the decoded frame.

13. Apparatus according to claim 12 wherein the estimator uses using frames adjacent the frame to be decoded to form the approximation of the frame.

14. Apparatus according to claim 13 wherein the apparatus is iterative and the frames adjacent are selected from the group consisting of a decoded key frame, and a decoded frame from a previous iteration.

15. Apparatus according to claim 13 wherein the adjacent frames are used to estimate the frame approximation using at least one of motion estimation, interpolation and extrapolation.

16. Apparatus according to claim 12 wherein the measurer forms structural similarity measures based upon the frame approximation and a decoded key frame, wherein the structural similarity measures are formed based upon a comparison of blocks of each of the frame approximation and the decoded key frame.

17. Apparatus according to claim 16 further comprising means for forming structural similarity measures for at least two of a bock-wise temporal measure, a block-wise spatial measure and an extended temporal measure and comparing each measure with a corresponding threshold, and associating a corresponding measure with each block of the frame approximation.

18. Apparatus according to claim 16 wherein the reconstructor comprises a turbo decoder for processing the data facilitating error correction, the similarity measures and a representation of the frame approximation, wherein the data facilitating error correction comprises parity data and the representation of the frame approximation comprises systematic data extracted from the frame approximation, the similarity measures being used with the parity and systematic data for the calculation of branch metrics for use in turbo decoding, wherein a result of said turbo decoding forms the decoded frame associated with the first and second fields, and an input for step (ii) for decoding of a subsequent frame.

19. A computer readable storage medium having a computer program recorded thereon, the program being executable by computer apparatus to decode a frame of video data encoded in a format having a first field comprising a plurality of encoded key frames and a second field comprising data facilitating error correction of an approximation of the frame to be decoded using the first field, said program comprising:
code for decoding at least two key frames from the first field;
code for determining the approximation of the frame from the decoded key frames;
code for determining a reliability (1165; 1265) for each of at least parts of the approximation; and
code for applying said data facilitating error correction to the approximation of the frame, based on the determined reliabilities for said parts to thereby form the decoded frame.

20. A computer readable storage medium having a computer program recorded thereon, the program being executable by computer apparatus to decode a non-key frame of a stream of frames of video data encoded in a format having a first field comprising a plurality of encoded key frames and a second field comprising parity data facilitating reconstruction of the non-key frame to be decoded, said program comprising:
code for decoding at least two key frames from the first field;
code for determining an approximation frame from the decoded key frames;
code for determining a reliability for of the approximation frame; and
code for applying said parity data to the approximation frame, based on the determined reliability to thereby form the decoded non-key frame.
